(19) United States
(12) Patent Application Publication
(10) Pub. No.: US 2009/0151411 A1
(43) Pub. Date: Jun. 18, 2009

(54) LOCKING DEVICE FOR VEHICLE

(75) Inventors: Sangsub Um, Seoul (KR); Yongbeom Ko, Ansan-si (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/326,740

(22) Filed: Dec. 2, 2008

(30) Foreign Application Priority Data
Dec. 15, 2007 (KR) 10-2007-0131732

(51) Int. Cl. B60R 25/00

(52) U.S. Cl. 70/237

(57) ABSTRACT

A locking device for a vehicle that is equipped with a rotor having a notch to break the rotor when an excessive external force is applied from the outside may include a retaining groove that is recessed from outer surface of the rotor toward the center thereof, and/or a locking pin coupling the rotor and a rotor case, the locking pin inserted into the retaining groove of the rotor through the rotor case, wherein the rotor is rotatably coupled to the rotor case therein.

### CROSS-REFERENCE TO RELATED APPLICATION

The present application claims priority to Korean Patent Application Number 10-2007-0131732 filed Dec. 15, 2007, the entire contents of which application is incorporated herein for all purposes by this reference.

### BACKGROUND OF THE INVENTION

1. Field of the Invention

The present invention relates to a locking device for a vehicle, particularly technology that improves antitheft function of vehicles by making a locking device for locking and unlocking the doors, the tail gate, and the trunk lid of the vehicles, difficult to be forcibly unlocked.

2. Description of Related Art

FIGS. 1 and 2 are an assembly diagram and an exploded perspective view of a locking device in the related art, respectively, in which a rotor is rotatably inserted in a rotor case 500, a plurality of tumblers 504 are provided in rotor 502. Tumblers 504 have different stepped-heights according to codes formed by the shapes of keys and each of tumblers 504 protrudes outside rotor 502 by a spring and retained such that it cannot rotate with respect to rotor case 500. Accordingly, when a key with a fitted code is inserted into rotor 502, tumblers 504 are retracted into rotor 502, such that rotor 502 can rotate without being disturbed by rotor case 500.

Further, a rod 506 or a lever is connected to rotor 502 to make it possible to actuate latch mechanism.

On the other hand, a thief may forcibly unlock the locking device from the outside of a vehicle, without using a key for the vehicle. For example, a thief can make rod 506 or the lever connected to rotor 502 unlock the latch by inserting a tool, such as a driver or scissors, into the key hole of rotor 502 and then hitting the tool in the axial direction of rotor 502 while shaking it up/down and left/right to unlock tumblers 504 and rotate rotor 502.

Two methods for preventing rotor 502 from being rotated by the tool as described above are known in the art, and one of which is to form a notch on rotor 502 such that the middle portion of rotor 502 is broken when an excessive force is applied to rotor 502, and the other one is to apply free wheeling mechanism that makes rotor 502 run idle.

It takes a large cost to apply the free wheeling mechanism, whereas the method of forming a notch on rotor 502 can be simply achieved at a low cost, but cannot completely prevent robbery by the tools.

That is, rotor 502 may be rotated engaged with tumblers 504 even though the notched portion of rotor 502 is broken when rotor 502 is rotated by the tools. Further, even when the notched portion is broken and the head portion of rotor 502 is separated, the thief can rotate rod 506 or the lever by inserting again the tool, such as a driver, and rotating it after removing the head portion of rotor 502, the fragments, and tumblers 504 outside using the tool.

The head portion of rotor 502 is the outer portion of rotor 502 where the key is inserted.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a locking device for a vehicle improving the antitheft function of the vehicle by preventing or delaying a forcible operation of the locking device while making the locking device with a simple configuration and at a low cost.

In an aspect of the present invention, a locking device for a vehicle that is equipped with a rotor having a notch to break the rotor when an excessive external force is applied from the outside, may include a retaining groove that is recessed from outer surface of the rotor toward the center thereof, and/or a locking pin coupling the rotor and a rotor case, the locking pin inserted into the retaining groove of the rotor through the rotor case, wherein the rotor is rotatably coupled to the rotor case therein.

The notch may be formed adjacent to a tumbler provided in the rotor.

The retaining groove may be disposed in front of the notch so that when the notch is broken, a head portion of the rotor is not separated from the rotor case by the locking pin.

The retaining groove may be disposed at a head portion of the rotor.

The retaining groove may be spaced from the tumbler provided in the rotor with a predetermined distance.

The retaining groove may be more recessed from the outer surface of the rotor than the notch.

The locking pin may be inserted into the retaining groove of the rotor through a pin hole formed at the rotor case wherein the pin hole is not exposed to the outside of the locking device after the rotor and the rotor case are assembled together.

The locking pin may not be exposed outside the rotor case after inserted into the retaining groove of the rotor through the rotor case.

Thickness of the retaining groove in longitudinal direction of the rotor may be larger than that of the locking pin so as to form a buffering space therein so that when the external force is applied to the rotor, the locking pin is not broken.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is an assembled locking device for an exemplary vehicle.

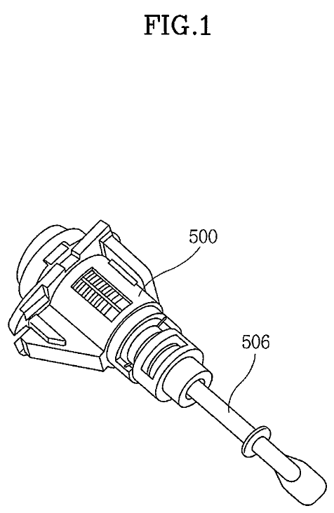

FIG. 2 is an exploded perspective view of FIG. 1.

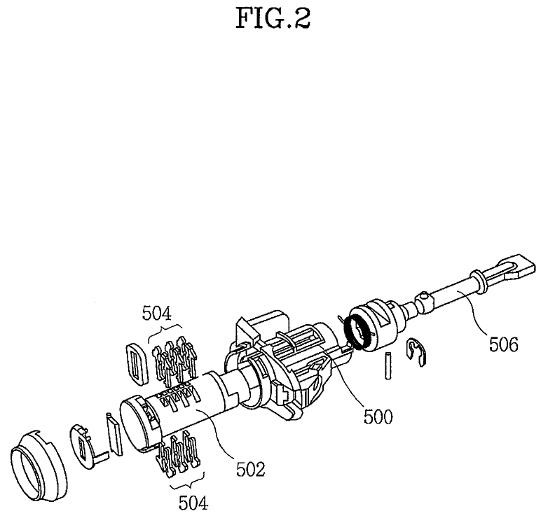

FIG. 3 is a view illustrating an exemplary locking device according to the invention.

FIG. 4 is a cross-sectional view of an exemplary locking device according to the invention.

FIG. 5 is a detailed view showing the rotor shown in FIG. 3.

FIG. 6 is a detailed view showing the rotor case shown in FIG. 3.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

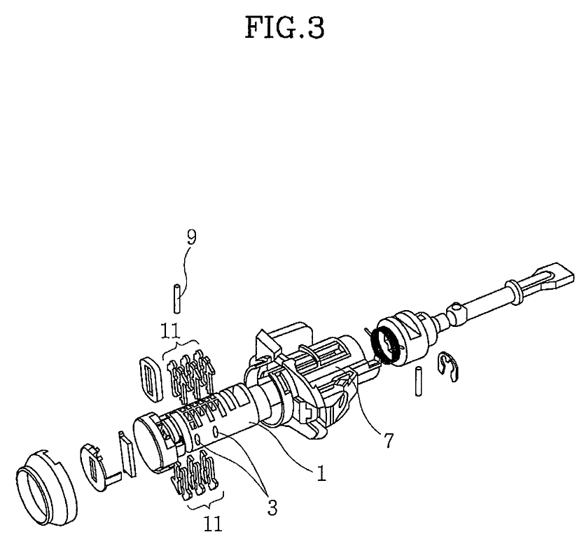

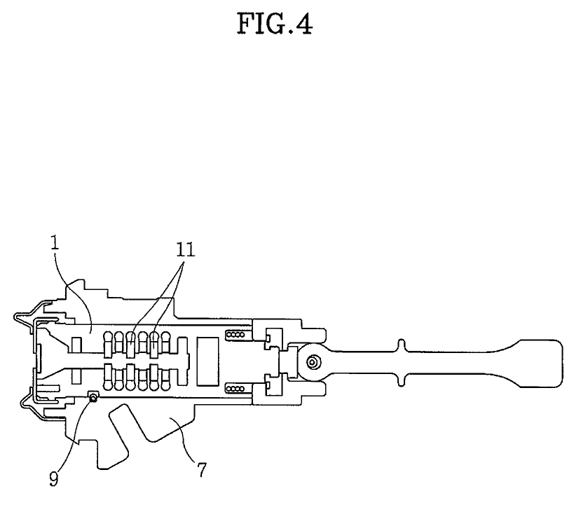

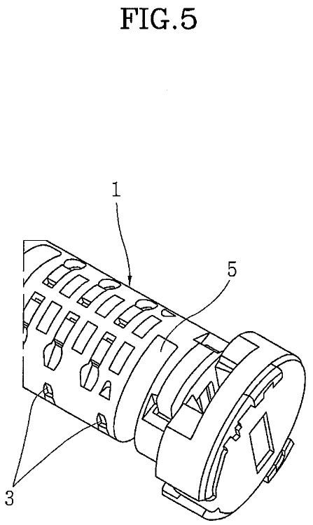

Referring to FIGS. 3 to 5, according to various embodiments of the present invention, a locking device for a vehicle is provided with a rotor 1 having at least a notch 3 that make rotor 1 broken when an excessive force is applied.

A plurality of tumblers 11 are provided in rotor 1 and the notches 3 are formed on the outer surface of the rotor 1, that is, on the outer circumference of rotor 1. The rotor 1 may be provided with first to fourth tumblers 11 sequentially arranged from the head portion of rotor 1, as shown in the figures.

In various embodiments of the present invention, the notch 3 is disposed adjacent to the tumblers 11 so that the portion where the notch 3 is formed is easily broken when an excessive force is applied from the outside.

In various embodiments of the present invention, the locking device has a retaining groove 5 that is recessed from the outer surface of the rotor along the circumference of rotor 1.

The retaining groove 1 may be more recessed from the outer surface of the rotor than notches 3.

A locking pin 9 is configured to be inserted into the retaining groove 5 so as to lock the rotor 1 to the rotor case 7.

In various embodiments of the present invention, the retaining groove 1 is disposed at the head portion of the rotor 1 so that the head portion of rotor 1 does not come out of rotor case 7 by retaining groove 5 and locking pin 9, even if notches 3 of rotor 1 are broken by a force that forcibly rotates rotor 1.

The thickness of the retaining groove 1 in the longitudinal direction of the rotor 1 is larger than that of the locking pin 9 to make a buffering space so that when the external force is applied to the rotor 1, the locking pin 9 is not broken.

It is preferable that the retaining groove 5 is disposed in front of the portion where tumblers 11 are positioned so that when the notch 3 is broken, the head portion of the rotor 1 may not be separated from the rotor case 7.

It may be difficult to form retaining groove 5 to where tumblers 11 are formed. Even if tumblers 11 are configured to be non-uniformly arranged and it is possible to form retaining groove 5 to where tumblers 11 are positioned, once retaining groove 5 is formed where tumblers 11 are positioned, it may help notches 3 breaking rotor 1 and it may be difficult to achieve an object of the present invention for preventing the head portion of rotor 1 from coming outside.

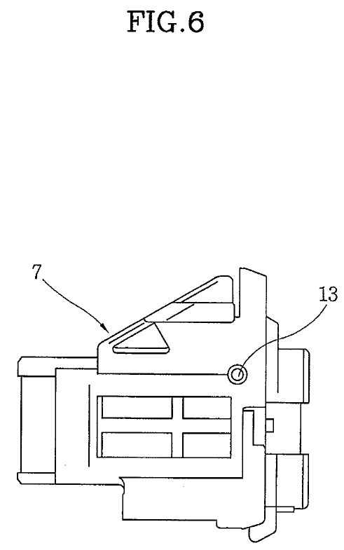

As shown in FIG. 6, a pin hole 13 is formed through rotor case 7 to insert locking pin 9. Pin hole 13 is not exposed to the outside of the locking device.

The operation of the locking device having the above configuration according to various embodiments of the present invention is described hereafter.

When an excessive force that forcibly rotates the rotor 1 is applied from the outside, the portions of rotor 1 where notches 3 are formed are first broken, such that even though the head portion of rotor 1 is rotated by the force applied from the outside, the rod or lever connected to rotor 1 is not actuated while the head portion of rotor 1 cannot come out of rotor case 7.

That is, although the portions of rotor 1 where notches 3 are formed are broken, movement of the head portion of rotor 1 in the longitudinal direction of rotor 1 is limited by retaining groove 5 and locking pin 9, such that it cannot come out of rotor case 7.

It may be possible to remove the head portion of rotor 1 by hitting and breaking the head portion of rotor 1, but this takes more time. Therefore, this configuration can implement a more advantageous function in antitheft.

According to various aspect of the present invention, it is possible to improve the antitheft function of the vehicle by preventing or delaying a forcible operation of the locking device while making the locking device with a simple configuration and at a low cost.

For convenience in explanation and accurate definition in the appended claims, the terms “up”, “down”, “front”, and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A locking device for a vehicle that is equipped with a rotor having a notch to break the rotor when an excessive external force is applied from the outside, comprising:
a retaining groove that is recessed from outer surface of the rotor toward the center thereof; and
a locking pin coupling the rotor and a rotor case, the locking pin inserted into the retaining groove of the rotor through the rotor case;
wherein the rotor is rotatably coupled to the rotor case therein.

2. The locking device as defined in claim 1, wherein the notch is formed adjacent to a tumbler provided in the rotor.

3. The locking device as defined in claim 1, wherein the retaining groove is disposed in front of the notch so that when the notch is broken, a head portion of the rotor is not separated from the rotor case by the locking pin.

4. The locking device as defined in claim 1, wherein the retaining groove is disposed at a head portion of the rotor.

5. The locking device as defined in claim 1, wherein the retaining groove is spaced from the tumbler provided in the rotor with a predetermined distance.

6. The locking device as defined in claim 1, wherein the retaining groove is more recessed from the outer surface of the rotor than the notch.

7. The locking device as defined in claim 1, wherein the locking pin is inserted into the retaining groove of the rotor through a pin hole formed at the rotor case wherein the pin hole is not exposed to the outside of the locking device after the rotor and the rotor case are assembled together.

8. The locking device as defined in claim 1, wherein the locking pin is not exposed outside the rotor case after inserted into the retaining groove of the rotor through the rotor case.

9. The locking device as defined in claim 1, wherein thickness of the retaining groove in longitudinal direction of the rotor is larger than that of the locking pin so as to form a buffering space therein so that when the external force is applied to the rotor, the locking pin is not broken.

10. A passenger vehicle comprising the locking device as defined in claim 1.
